(19) United States
(12) Patent Application Publication
(10) Pub. No.: US 2012/0191547 A1
(43) Pub. Date: Jul. 26, 2012

(54) DYNAMIC VALUE ADVERTISING

(75) Inventors: Matthew Ahrens, Champaign, IL (US); Greg Muchnik, Champaign, IL (US)

(73) Assignee: Yahoo! Inc., Sunnyvale, CA (US)

(21) Appl. No.: 13/014,280

(22) Filed: Jan. 26, 2011

(51) Int. Cl. G06Q 30/00

(52) U.S. Cl. 705/14.68; 705/14.4

(57) ABSTRACT

A system for generating advertisements is provided. The system includes an advertisement server, advertisement storage, and user activity storage. The advertisement server receives a request for an advertisement. The advertisement storage is in communication with the advertisement server. The advertisement storage includes a format for the advertisement and a pre-defined formula for calculating a value for the advertisement. The user activity storage is in communication with the advertisement server. The advertisement server calculates the value for the advertisement based on the formula and user data from the user activity storage.

### BACKGROUND

1. Field of the Invention

The present invention generally relates to a system for generating an advertisement.

2. Description of Related Art

Currently, display ads are static images that are submitted by advertisers for specific campaigns. Advertisers do not have any way to dynamically change the content of their ads based on real-time information regarding how users are responding to a specific offer. Rather, this concept has not been previously contemplated.

In view of the above, it is apparent that there exists a need for and improved method and system for generating advertisements.

### SUMMARY

A system for generating advertisements is provided. The system includes an advertisement server, advertisement storage, and user activity storage. The advertisement server receives a request for an advertisement. The advertisement storage is in communication with the advertisement server. The advertisement storage includes a format for the advertisement and a pre-defined formula for calculating a value for the advertisement. The user activity storage is in communication with the advertisement server. The advertisement server calculates the value for the advertisement based on the formula and user data from the user activity storage.

Further objects, features and advantages of this application will become readily apparent to persons skilled in the art after a review of the following description, with reference to the drawings and claims that are appended to and form a part of this specification.

### BRIEF DESCRIPTION OF THE DRAWINGS

The drawings described herein are for illustration purposes only and are not intended to limit the scope of the present disclosure in any way.

FIG. 1 is an illustration of a system for generating advertisements;

FIG. 2 is an illustration of a system for capturing user activity;

FIG. 3 is a flowchart illustrating a method of generating advertisements.

FIG. 4 is a schematic view of a computer for implementing the methods described herein.

It should be understood that throughout the drawings, corresponding reference numerals indicate like or corresponding parts and features.

### DETAILED DESCRIPTION

The system described herein allows an advertisement to have a portion that is dynamically computed in real-time based on user activity. This allows an advertiser to submit a formula along with their advertisement that specifies a portion of their advertisement (such as price or other incentive) that can change. Also, the advertiser can take advantage of network-wide user activity to determine the change to the advertisement; for example, an advertiser can specify that the price of their offering changes based on a certain number of views, clicks, or conversions being achieved.

The system can allow an advertiser to customize their offer to change parts of their ad in real-time based on user activity.

For the advertiser, the invention could involve the following steps:
1) An advertiser submits an advertisement with a specified portion of it to be deemed as dynamic. This could be a portion of an image or a piece of text in the ad.
2) The advertiser submits a computation formula for the dynamic piece.

The formula could be one of many options in the advertising product. The formula would specify a default value along with what events will change the value and to what values. An example would be an advertiser specifying a offer for a product priced at $30 as the default value. The“$30” would be the dynamic value, and the advertiser would specify that the value would increase (or decrease by $1) for every 1000 clicks that the ad receives.

From the advertisement serving side, the invention could involve the following steps:
1) When serving a dynamic value advertisement, the advertisement server would render the static image and fetch the dynamic piece based on the computation formula given by the advertiser. (The formula could be embedded in the URL of the dynamic piece.)
2) The advertisement server would determine what user activity data would need to be referenced to complete the formula for the dynamic piece of the advertisement.
3) The advertisement server would perform a lookup of the user activity data and compute that dynamic value for the advertisement.

A single ad could have multiple dynamic pieces. In addition, a dynamic piece of an ad could be alpha text (as opposed to numeric) if a specific text translation was given by the advertiser

Additional examples of how advertisers could use the invention:

Example 1: Better Price for All—An advertiser would like to create “herd” effect by offering a better price as number of customers increases.

Example 2: Better Price for the next X number of purchases (or X hours)—Advertiser wants incentive for customers to act quickly.

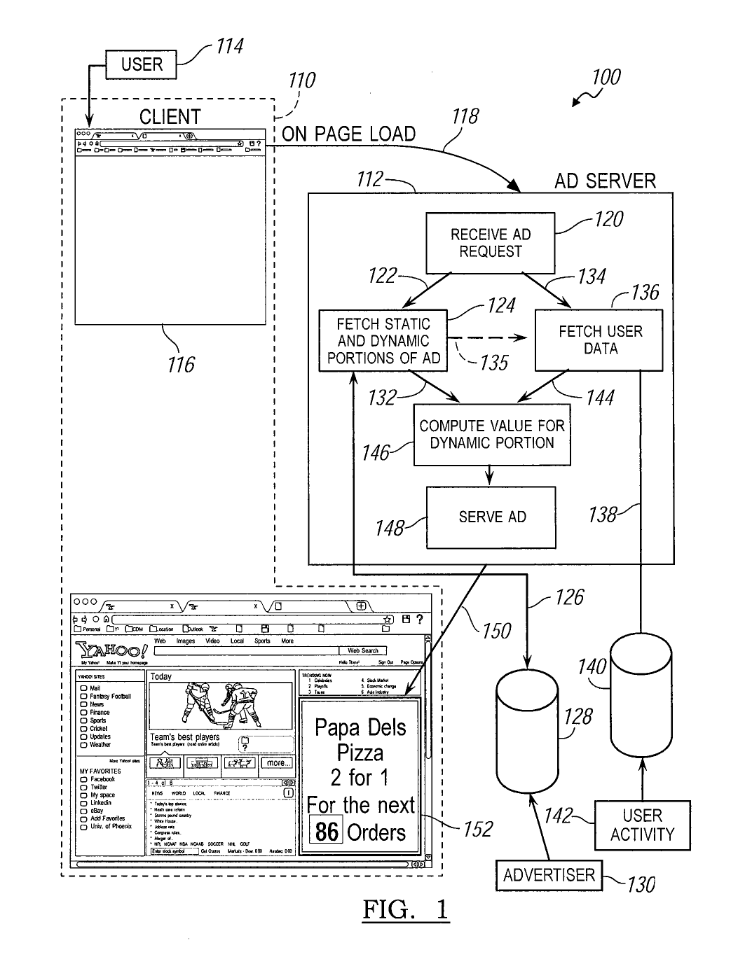

Now referring to FIG. 1, a system 100 is provided for generating an advertisement. The client device 110 interacts with an add server 112 to retrieve the advertisement. In one example, the user 114 accesses a web page 116 on the client device 110. As the client device 110 retrieves the web page 116, code on web page 116 may request an advertisement from the ad server 112, as denoted by line 118. The code may be HTML, JAVA, ASP or other executable module. For example, the advertisement may be requested upon page load. The ad server 112 receives the ad request as denoted by block 120. The method may then follow line 122 to block 124. In block 124, the static and dynamic portion of the advertisement may be acquired. As such, the ad server 112 may be in communication with an advertisement data store 128, as denoted by line 126. An advertiser 130 may communicate with the advertisement data store 128 to input the static and dynamic portions of the advertisement. The static portions of the advertisement may include the advertisement format, certain text and graphics. The dynamic portions of the advertisement may include formulas for calculating advertisement values based on user data. The formulas may calculate advertisement values including, but not limited to, values such as the price of the offer, quantity of the offer, or a time factor of the offer.

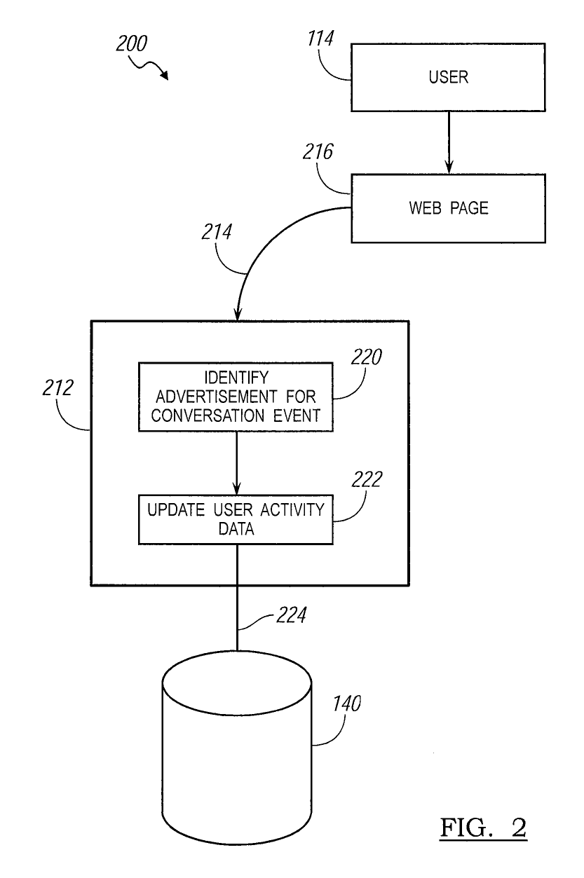

Then in a parallel fashion as denoted by line 134, or in a sequential fashion as denoted by line 135, the ad server may fetch user data from a user data store 140. The user data store 140 is in communication with the ad store 112 as denoted by line 138. The user data store 140 may include information for example, but not limited to, the number of times the advertisement is clicked on, the number of times the advertisement is converted, or the number of times that an advertisement is displayed. As such, the formulas retrieved from the advertisement data store 128 may be calculated based on the variables retrieved from the user data store 140. User activity 142 represents activity by the user which may be captured through various methods of processes. One example is further provided with reference to FIG. 2. As denoted by lines 132, the calculating parallel or line 144, the method proceeds to block 146 where the values for the dynamic portions of the advertisement are calculated according to the formulas and the user data collected. The method then proceeds to block 148 where the advertisement is compiled and served to the client. The advertisement is provided from the ad server 112 to the client as denoted by line 150. The advertisement 152 is then displayed on the web page with the dynamic and static portions seamlessly integrated for the user. In this manner, the offer is computed in real time based on the real time user activity. Further, the advertisement is recomputed each time the ad is served according to a pre-defined formula. Further, values through advertisement may be computed according to one or more formulas selected based on the stored user activity where the values are also calculated in each formula based on the stored user activity.

Now referring to FIG. 2, the system 200 is provided for capturing user activity as it is used in reference to FIG. 1. The user 114 interacts with the web page 216 which may be the same web page as 116 denoted in FIG. 1 or a separate web page, for example, a purchase web page for tracking conversions of an advertisement. Conversions may, for example, include purchases, redemptions, transactions or other activity on the advertiser's website. The web page 216 notifies the advertisement server 212 which may be the same advertisement server 112 denoted in FIG. 1 or may be a second advertisement server running parallel to gather user activity information. The user activity information from web page 216 is provided to the advertisement server 212 as denoted by line 214. The advertisement server 212 identifies the advertisement for event notification as denoted by block 220. In block 222, the advertising server 212 updates the user activity data in the database 140 as denoted by line 224. The updating of this data may happen concurrently with the serving of the advertisements as discussed with regard to FIG. 1. Accordingly, the values for the advertisements are continuously updated each time the advertisement is served.

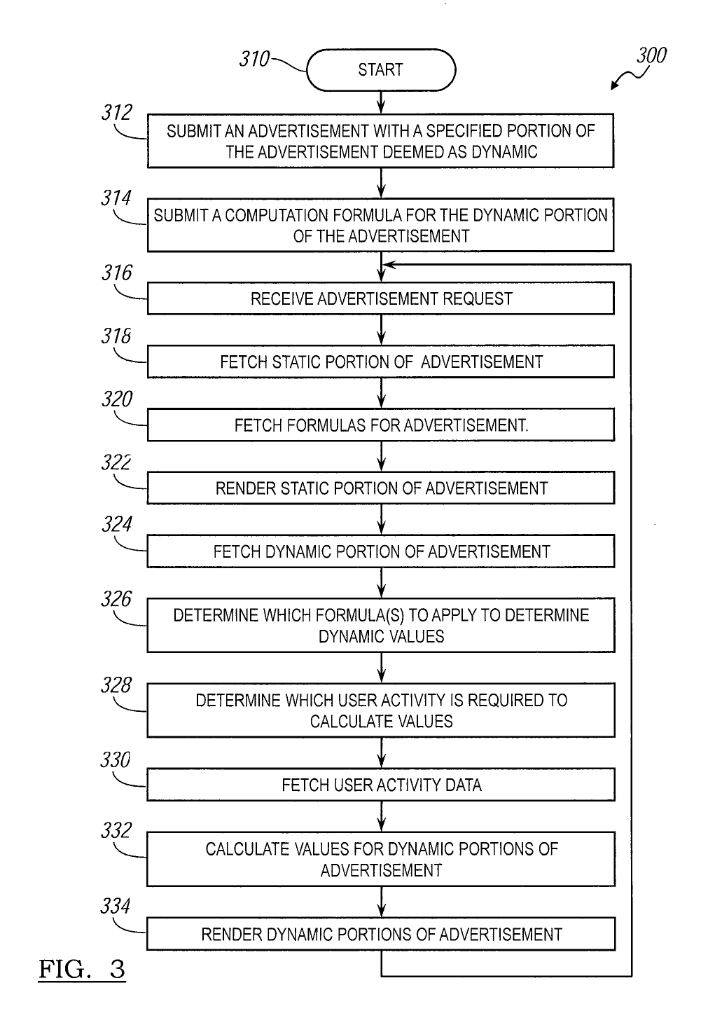

Now referring to FIG. 3, a method 300 is provided for generating an advertisement. The method starts in block 310. In block 312, an advertiser submits an advertisement with a specified portion of the advertisement deemed as dynamic. In block 314, the advertiser submits at least one computation formula for the dynamic portion of the advertisement. The system receives an advertisement request, as denoted by block 316. In block 318, the static portion of advertisement is fetched, for example from an advertisement data store such as a database. In block 320, formulas for advertisement are fetched. In block 322, the system renders the static portion of advertisement. The dynamic portion of advertisement is fetched, as denoted by block 324. In block 326, the system determines which formula (s) to apply to determine dynamic value(s). In block 328, the system determines which user activity is required to calculate values. The user activity data is fetched, as denoted in block 330. The user activity data may be fetched from a user activity data store, such as a database. In block 332, the system calculates values for dynamic portions of advertisement. In block 334, the system renders the dynamic portions of advertisement. The system then proceeds to block 316, where addition advertisements may be generated. In this manner, the user activity data may be updated simultaneously and accordingly the values for the advertisements may be dynamically calculated each time the advertisement is served.

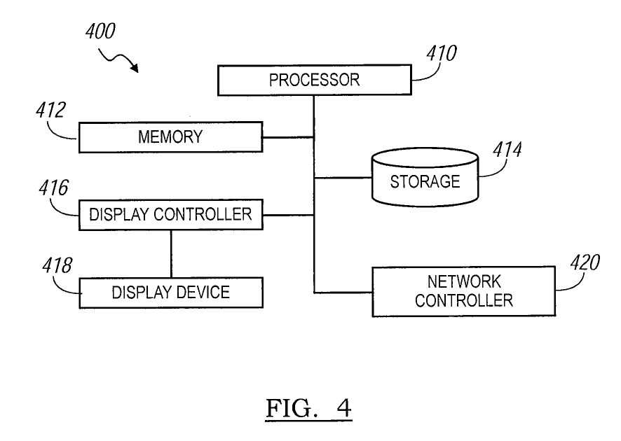

Any of the modules, servers, or engines described may be implemented in one or more computer systems. One exemplary system is provided in FIG. 4. The computer system 400 includes a processor 410 for executing instructions such as those described in the methods discussed above. The instructions may be stored in a computer readable medium such as memory 412 or storage devices 414, for example a disk drive, CD, or DVD. The computer may include a display controller 416 responsive to instructions to generate a textual or graphical display on a display device 418, for example a computer monitor. In addition, the processor 410 may communicate with a network controller 420 to communicate data or instructions to other systems, for example other general computer systems. The network controller 420 may communicate over Ethernet or other known protocols to distribute processing or provide remote access to information over a variety of network topologies, including local area networks, wide area networks, the Internet, or other commonly used network topologies.

The system described herein allows the provider to offer a compelling new way for their advertisers to have a more customizable and dynamic offering to customers. It gives the advertisers more flexibility and it gives the provider a competitive advantage in their advertising products space.

In other embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. A system for generating advertisements, the system comprising:
an advertisement server receiving a request for an advertisement;
an advertisement storage in communication with the advertisement server, the advertisement storage including a format for the advertisement and a pre-defined formula for calculating a value for the advertisement; and
an user activity storage in communication with the advertisement server, the advertisement server calculating the value for the advertisement based on the pre-defined formula and user data from the user activity storage.

2. The system according to claim 1, wherein the advertisement server retrieves user data and calculates the value for the advertisement after receiving the request for the advertisement.

3. The system according to claim 1, wherein the advertisement server recalculates the value each time the advertisement is served according to the pre-defined formula.

4. The system according to claim 1, wherein the pre-defined formula is one of a plurality of pre-defined formulas and the value is one of a plurality of calculated values for the advertisement, each value of the plurality of calculated values being calculated according to a corresponding formula of the plurality of pre-defined formulas.

5. The system according to claim 1, wherein the pre-defined formula is one of a plurality of pre-defined formulas and the pre-defined formula for calculating the value is selected from the plurality of pre-defined formulas based on the user activity data.

6. The system according to claim 1, wherein the user activity includes the number of times an advertisement is clicked and the formula calculates the value based on a number of times an advertisement is clicked.

7. The system according to claim 1, wherein the user activity includes the number of times an advertisement is converted and the formula calculates the value based on a number of times an advertisement is converted.

8. The system according to claim 1, wherein the user activity includes the number of times an advertisement is displayed and the formula calculates the value based on a number of times an advertisement is displayed.

9. The system according to claim 1, wherein the valued is a quantity of an offer and the formula calculates the quantity based on the user data.

10. The system according to claim 1, wherein the valued is a price of an offer and the formula calculates the price based on the user data.

11. The system according to claim 1, wherein the valued is a time factor of an offer and the formula calculates the time factor based on the user data.

12. A method for generating advertisements, the method comprising:
requesting an advertisement;
retrieving a format for the advertisement and a pre-defined formula for calculating a value for the advertisement; and
calculating the value for the advertisement based on the pre-defined formula and user activity data.

13. The method according to claim 12, wherein the steps of retrieving the user activity data and calculating the value for the advertisement occurs after receiving the request for the advertisement.

14. The method according to claim 12, further comprising recalculating the value each time the advertisement is served according to the pre-defined formula.

15. The method according to claim 12, wherein the pre-defined formula is one of a plurality of pre-defined formulas and the value is one of a plurality of calculated values for the advertisement, each value of the plurality of calculated values being calculated according to a corresponding formula of the plurality of pre-defined formulas.

16. The method according to claim 12, wherein the pre-defined formula is one of a plurality of pre-defined formulas and the pre-defined formula for calculating the value is selected from the plurality of pre-defined formulas based on the user activity data.

17. In a computer readable storage medium having stored therein instructions executable by a programmed processor for generating an advertisement, the storage medium comprising instructions for:
requesting an advertisement;
retrieving a format for the advertisement and a pre-defined formula for calculating a value for the advertisement; and
calculating the value for the advertisement based on the pre-defined formula and user activity data.

18. The computer readable storage medium according to claim 17, wherein the instructions for retrieving the user activity data and calculating the value for the advertisement are executed after receiving the request for the advertisement.

19. The computer readable storage medium according to claim 17, further comprising instructions for recalculating the value each time the advertisement is served according to the pre-defined formula.

20. The computer readable storage medium according to claim 17, wherein the pre-defined formula is one of a plurality of pre-defined formulas and the value is one of a plurality of calculated values for the advertisement, each value of the plurality of calculated values being calculated according to a corresponding formula of the plurality of pre-defined formulas.

21. The computer readable storage medium according to claim 17, wherein the pre-defined formula is one of a plurality of pre-defined formulas and the pre-defined formula for calculating the value is selected from the plurality of pre-defined formulas based on the user activity data.
